(19) United States
(12) Patent Application Publication
(10) Pub. No.: US 2016/0288238 A1
(43) Pub. Date: Oct. 6, 2016

(54) METHOD OF ELECTRIC ARC SURFACING WITH GAS PROTECTION CONSISTING OF AN ARGON/HELIUM GAS MIXTURE

(71) Applicant: L'AIR LIQUIDE, SOCIÉTÉ ANONYME POUR L'ETUDE ET L'EXPLOITATION DES PROCÉDÉS GEORGES CLAUDE, Paris (FR)

(72) Inventor: Jean-Pierre PLANCKAERT, Monneville (FR)

(21) Appl. No.: 15/034,768

(22) PCT Filed: Nov. 4, 2014
(86) PCT No.: PCT/FR2014/052794

§ 371 Date: May 5, 2016

(30) Foreign Application Priority Data
Nov. 7, 2013 (FR) 1360884

(51) Int. Cl. B23K 9/167; B23K 9/12; B23K 35/38; B23K 9/04

(52) U.S. Cl. CPC B23K 9/167; B23K 9/04; B23K 9/124; B23K 35/383

(57) ABSTRACT

The invention relates to a process for cladding at least one portion of a metal part, the process implementing a non-consumable electrode, a consumable metal filler wire, and an electric arc drawn between the electrode and the part so as to produce a molten metal puddle, the end of the metal filler wire being melted by the electric arc so as to achieve a transfer of molten metal from the filler wire to the molten metal puddle and to coat at least one portion of the part with a metal deposit. According to the invention, the process uses a shielding gas to shield the electrode, the filler wire and the puddle, with a gas mixture containing 20 to 70% helium, and argon for the rest (% by volume).

### CROSS REFERENCE TO RELATED APPLICATIONS

This application is a 371 of International PCT Application PCT/FR2014/052794 filed Nov. 4, 2014, which claims priority to French Patent Application No. 1360884 filed Nov. 7, 2013, the entire contents of which are incorporated herein by reference.

### BACKGROUND

The invention relates to a process for TIG cladding at least one portion of a metal part, having a greatly improved productivity and deposition characteristics.

Cladding is a process consisting in coating a part, or a portion of a part, or substrate, with a deposit, the bond between the cladding deposit and the substrate being achieved electrically, mechanically or thermally depending on the nature of materials employed.

In general, cladding operations take place during the manufacture or maintenance of parts. These operations are mainly carried out to improve the resistance of the parts to various stresses, such as abrasion, pressure and/or corrosion, or to repair parts subjected to severe wear conditions. The protection of tubes from corrosion or the surface cladding of valves are exemplary applications.

The coating and the substrate are most often formed from metals, the cladding material possibly, depending on the case, being identical to or different from that of the substrate. The composition of the cladding deposit is defined and controlled so as to be the most suitable for the conditions of use.

Most conventional welding processes may be used to produce cladding deposits. The cladding is then carried out by melting the surface of a metal substrate so as to produce a molten metal puddle, and melting a metal filler that is transferred to the molten metal puddle so as to bond it to the base metal of the substrate and create the cladding deposit. Mention may be made, by way of example, of shielded electrode weld cladding, metal inert gas/metal active gas (MIG/MAG) weld cladding, plasma weld cladding and tungsten inert gas (TIG) weld cladding.

However, none of the existing processes are entirely satisfactory.

Thus, although it is relatively simple and flexible, electrode welding forms an adherent slag on the surface of the cladding deposit, this slag having to be removed after each pass. Furthermore, electrode welding yields low deposition rates, typically between 0.5 to 2 kg/h, and high degrees of dilution of the filler metal by the metal of the substrate, of about 30 to 50%.

It will be noted that dilution is the unavoidable mixing of the base metal and the filler metal deposited during the welding. The aim is to minimize this dilution in order to optimize the properties of the cladding deposit.

Typically, degrees of dilution from 5 to 20% and preferably smaller than 10% are considered to be low, whereas degrees of dilution of more than 30%, or even more than 50%, are high.

As regards deposition rate, values of about 2 kg/h at most are low. By high deposition rate, what is meant is deposition rates of at least 5 kg/h and preferably at least 6 kg/h.

MIG/MAG weld cladding often involves the use of a flux-cored wire by way of consumable electrode, the desired constituent materials of the cladding deposit not being available in solid-wire form. This also leads to the formation of a slag that must be removed before carrying out the following pass(es). The deposition rates obtained are high, in general between 5 and 6.5 kg/h, but MIG/MAG welding leads to high degrees of dilution, of about 30 to 50%.

As for plasma cladding, it yields low degrees of dilution and little deformation of the substrate, because the amount of heat delivered is finely controllable. However, the process is complicated and expensive to implement, the equipment requiring a combination of a heating system to melt the filler metal and a plasma torch to melt the base metal.

TIG cladding relies on the use of an electric arc drawn between the non-consumable electrode and the substrate to be coated, the end of a consumable metal wire being melted by the arc so as to deliver filler metal to the molten puddle and create the deposit. TIG generates deposits with low degrees of dilution, typically from 5 to 20%, and little deformation of the substrate to be clad, the substrate being heated less.

However, TIG cladding yields deposition rates that have conventionally been limited to values of about 2 to 2.5 kg/h, essentially because of the small amount of heat delivered by the arc to the substrate. This degrades the productivity of the TIG cladding process, productivity being essentially governed by the deposition rate.

Furthermore, the TIG process requires the distance separating the juxtaposed beads produced in succession so as to form the deposit to be precisely controlled. If such a control is not achieved, in particular if the distance between beads is too large, the deposited beads exhibit poor wetting and have an irregular appearance. The particular precautions that have to be implemented also degrade the overall productivity of the TIG cladding process.

In light thereof, the problem to be solved is to mitigate all or some of the aforementioned drawbacks. One aim of the present invention is especially to provide a cladding process with an improved productivity, achieved by producing cladding deposits with high deposition rates, especially of at least 4 kg/h, while nonetheless improving the morphology of the deposits produced in terms of wetting and penetration profile.

### SUMMARY

The solution of the invention is thus a process for cladding at least one portion of a metal part, said process implementing a non-consumable electrode, a consumable metal filler wire, and an electric arc drawn between the electrode and the part so as to produce a molten metal puddle, the end of the metal filler wire being melted by the electric arc so as to achieve a transfer of molten metal from the filler wire to the molten metal puddle and to coat at least one portion of the part with a metal deposit, characterized in that a shielding gas is used to shield the electrode, the filler wire and the puddle, with a gas mixture consisting of 20 to 70% helium, and argon for the rest (% by volume).

Moreover, depending on the embodiment in question, the invention may comprise one or more of the following features:
said gas mixture contains at most 50% helium (% by volume).
said gas mixture contains at most 30% helium (% by volume).
the shielding gas mixture consists of 20% helium and 80% argon (% by volume).
the shielding gas mixture consists of 70% helium and 30% argon (% by volume).
the transfer of molten metal to the molten metal puddle is achieved via a liquid bridge so as to have a permanent contact between said puddle and the molten end of the filler wire.
the end of the filler wire is guided so as to make an angle comprised between 5 and 50° to the axis of the electrode.
the end of the filler wire is guided and permanently maintained at a distance D smaller than 2 mm from the end of the electrode.
the end of the filler wire is guided so as to make an angle comprised between 10 and 25° to the axis of the electrode.
the non-consumable electrode is made of tungsten.
the part to be clad and/or the metal deposit deposited on said part is made of carbon steel, stainless steel, a nickel-based alloy or a cobalt-based alloy.
the metal deposit has a thickness comprised between 1 and 20 mm and preferably between 5 and 15 mm.

According to another aspect, the invention also relates to a cladding machine configured to implement the process of the invention. Advantageously, the machine comprises a TIG torch electrically connected to at least one current generator and fluidically connected to at least one gas source suitable for supplying the torch with a shielding gas mixture consisting of at least 20% helium, and argon for the rest (% by volume). Preferably, the machine comprises a movable beam or a robotic arm on which the TIG torch is arranged, said torch optionally being movable, and a digital control system suitable for controlling and designed to control the movement of the movable beam and/or the robotic arm relative to the part(s) to be clad.

### BRIEF DESCRIPTION OF THE DRAWING

For a further understanding of the nature and objects for the present invention, reference should be made to the following detailed description, taken in conjunction with the accompanying drawing, in which like elements are given the same or analogous reference numbers and wherein:

FIG. 1 illustrates a schematic representation of one embodiment of the present invention.

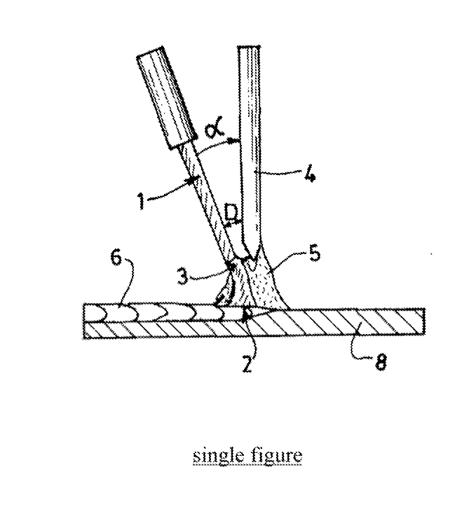

### DESCRIPTION OF PREFERRED EMBODIMENTS

The invention will now be better understood by virtue of the following detailed description given with reference to the single appended FIGURE illustrating one embodiment of the process according to the invention.

As may be seen in the FIGURE, the cladding process according to the invention implements a non-consumable electrode 4 and a consumable metal filler wire 1 arranged facing at least one part 8 to be clad. Preferably, the electrode 4 is made of tungsten and its end is formed from a tip having the shape of an axisym metric cone the apex angle of which is typically comprised between 20 and 40°.

The electrode 4 is supplied with current so as to draw an electric arc 5 between said electrode 4 and the part 8. The heat generated by the electric arc 5 allows the surface of the part 8 to be melted, typically to a depth of about 1 to 3 mm, and a molten metal puddle 2 to be formed.

Apart from the constituent metal of the part 8, the heat of the electric arc 5 allows the constituent metal of the filler wire 1 to be melted. The filler wire 1 is continuously fed in the direction of the electric arc 5 at a speed referred to as the wire speed. There follows a transfer of molten metal from the end of the wire 1 to the molten metal puddle 2. The liquid puddle formed from the base metal of the part 8 and the filler metal of the molten consumable wire solidifies and forms a cladding deposit 6.

A deposit 6 is obtained on at least one portion of the surface of the part 8 located facing the wire 1 of the electrode 4 via a relative movement of the assembly formed by the filler wire 1 and the electrode 4 relative to the surface of the part 8 to be clad. It will be noted that the cladding deposit 6 may comprise one or more weld beads deposited in succession on the part 8, said beads being juxtaposed or partially overlapping. The cladding deposit 6 may furthermore comprise one or more layers superposed on one another.

Furthermore, the process uses a shielding gas to shield the electric arc 5, the filler wire 1 and the molten metal puddle 2, in order to shield them from ambient air.

Pure argon (Ar) is conventionally envisioned in cladding with non-consumable electrodes for essentially economical reasons, but yields, in many cases, irregular beads and poor wetting.

The inventors of the present invention have demonstrated that the use of a gas mixture consisting of 20 to 70% helium (He) and argon for the rest in cladding processes implementing non-consumable electrodes yields a substantial increase in the productivity of the process, and an improvement in the appearance of the cladding deposits.

One possible explanation regards the higher ionization energy of helium relative to argon. With equivalent arc lengths and currents, the welding voltage obtained with helium is therefore higher than that obtained with argon. Since welding energy is directly related to the product of the current multiplied by the arc voltage, the energy delivered with helium is therefore higher than that delivered with argon.

However, such a line of reasoning would not predict the significant effect of a proportion of helium comprised between 20 and 70% in an Ar—He shielding mixture on productivity, or the improvement in the wetting and regularity of the cladding deposits. Specifically, considering that only 5 to 30% of the electric arc is ionized, it will be understood that only a very small number of helium atoms are ionized, producing only a limited number of He ions.

Unexpectedly, it is in fact the difference in the thermal conductivity of argon and helium that explains the beneficial effect of a gas mixture consisting of 20 to 70% helium and argon for the rest. Specifically, the thermal conductivity of monoatomic gases such as helium and argon depends on the diffusion coefficient of the atoms, itself proportional to the square root of the inverse of the mass of the atom in question. Thus, with an atomic mass ten times higher than that of helium, argon has a thermal conductivity equal to about 30% of that of helium.

However, thermal conductivity influences the radial loss of heat from the center of the electric arc column toward its periphery. Pure argon therefore produces an arc characterized by a narrow hot central zone and a rapidly much cooler peripheral zone. During a non-consumable electrode cladding operation the penetration profiles obtained with argon therefore have a relatively narrow shape.

Ar—He mixtures possess thermal conductivities having intermediate values located between that of argon and that of helium. The use of an Ar—He mixture therefore allows higher temperatures to be achieved in a wider zone around the arc column than with argon alone. Wider penetration profiles, a better wetting of the bead(s) forming the cladding deposit and an increased cladding speed follow because of the greater amount of energy delivered and the increase in the temperature of the welding puddle.

The beneficial influence of helium on the morphology of the deposits and on the productivity of the cladding process is detectable from 20% helium in argon. In contrast, above 70% helium, difficulties with striking and instabilities in the electrical arc appear. According to the invention, a shielding gas is therefore used, in an electric-arc cladding process, to shield the non-consumable electrode 4, the consumable metal filler wire 1 and the molten metal puddle 2, with a gas mixture consisting of 20 to 70% (% by volume) helium and argon for the rest.

Advantageously, said gas mixture contains at most 50% helium and preferably at most 30% helium (% by volume). Such helium proportions in the shielding gas mixture allow the increase in the cost of the gas resulting from the use of helium to be limited while significantly improving the cladding performance.

According to one preferred embodiment of the invention, the transfer of molten metal to the molten metal puddle 2 is achieved via a liquid bridge 3, or a vein of liquid metal, between the filler wire 1 and the zone of the part 8 to be clad so as to have a permanent contact between said puddle 2 and the molten end of the filler wire 1. In other words, the metal is not transferred dropwise, but in a liquid bridge 3 of molten metal.

A liquid-bridge transfer has the following advantages:
a point of impact below the arc, thereby facilitating the positioning of the electrode and of the filler wire implemented in the process according to invention;
well directed uninterrupted transfer of metal to the puddle;
a high-quality weld bead of attractive appearance, i.e. a very smooth surface that contains no striations resulting from the successive deposition of drops of liquid metal;
surface tension creates a constantly present transfer force that facilitates positional welding;
a facility in adjustment of the wire speed parameter since a surplus of wire may be absorbed in the puddle; and
the wire passes through the hottest zones of the arc; this has the effect of preheating the wire and implies a higher speed and efficiency. This effect is equivalent to what are referred to as “hot wire” processes, in which the preheating is achieved by Joule heating in the filler metal, whereas in our case the preheating energy is delivered directly by the electric arc.

Liquid-bridge metal transfer may be obtained in a wide and high range of wire feed speed parameters, typically at least 3 m/min, relative to the wire feed speeds used in dropwise transfer.

As may be seen in the FIGURE, the electrode 4 is oriented in a first direction, preferably perpendicular to the upper surface of the part 8. In the case of cladding of parts held flat, i.e. horizontally, the first direction of the electrode 4 therefore makes an angle of about 0° to the vertical. Alternatively, the angle made by said first direction of the electrode 4 to the vertical may be nonzero and take values ranging up to 15° on either side of the vertical direction.

The filler wire 1 is oriented in a second direction, said first and second directions preferably being substantially coplanar. Preferably, the plane containing the first and second directions is perpendicular to the surface of the part 8. Alternatively, said plane may make a nonzero angle ranging up to 15° to the direction perpendicular to the upper surface of the part 8.

The transfer via the liquid bridge 3 is preferably obtained by guiding the end of the filler wire 1 so as to make an angle α comprised between 5 and 50° to the axis of the electrode 4, as illustrated in the FIGURE. The filler wire 1 is thus not directed parallelly or horizontally to the surface of the part(s) to be welded and therefore touches the molten puddle without transfer to the arc.

Preferably, the wire is fed at an angle α ranging from 10° to 20°, and more preferably ranging from 15° to 20°, to the axis of the electrode 4.

Advantageously, to obtain an effective transfer of metal via the liquid bridge 3, the end of the filler wire 1 is guided and permanently maintained at a distance D smaller than 2 mm from the end of the electrode 4, i.e. the distance between the external surface of the consumable wire and the electrode must not exceed about 2 mm and is preferably about 1 mm. Specifically, if the wire/electrodes distance D becomes too large, i.e. larger than 2 mm, it becomes more difficult to obtain an effective and durable liquid-bridge transfer.

Preferably, the end of the non-consumable electrode 4 is positioned in front of the feed of filler wire 1 in the cladding direction and moves simultaneously therewith. Such a position limits disruption of the flows of molten metal and allows a high electrode/wire assembly movement speed to be maintained without generating defects in the deposit.

Optionally, the process according to the invention may comprise a step of preheating the filler wire 1, before it is melted by the electric arc 5, preferably by means of a Joule-heating-based heating mechanism. Using a wire subjected to an additional heat source allows the maximum wire feed speed to be increased.

The main application of the present invention is a process for cladding parts 8 formed from various metals, especially parts made of ferrous alloys (preferably stainless steel or carbon steel), nickel-based alloys or cobalt-based alloys.

The metal deposit 6 may comprise one or more superposed metal layers, be formed from stainless steel, a nickel-based alloy or a cobalt-based alloy, and have a thickness comprised between 1 and 20 mm and preferably between 5 and 15 mm.

The helium content of the shielding gas mixture according to the invention will possibly optionally be adapted depending on the desired cladding performance level. The more the target application demands deposits exempt from or with very few defects, excellent wetting and/or a high deposition rate, the more the proportion of helium in the shielding gas mixture must be increased. If it is important, for the overall productivity of the cladding machine, to maintain a reasonable cost for the shielding gas mixture, a proportion of helium in the shielding gas mixture of 50% at most and preferably of 30% at most will instead be used.

During the welding operation, the electric arc 5 is shielded by a flow of a shielding gas mixture advantageously distributed with a flow rate comprised between 6 and 12 l/min.

The cladding process according to the invention is advantageously carried out with a TIG torch (not illustrated). The TIG torch comprises, at its end located facing the parts 8 to be clad, the non-consumable electrode 4 and a nozzle suitable for distributing the shielding gas. The TIG torch is electrically connected to at least one current generator delivering a smooth or pulsed current, of about 200 to 400 Å, which torch is also fluidically connected to at least one gas source. All of these elements, namely the welding torch, current generator and gas source, and electrical supply cables, gas supply circuits and mechanical elements such as structural frame members and/or a movable beam and/or a robotic arm on which the torch is arranged are comprised in an assembly termed the TIG cladding machine. The TIG torch may be manually controlled or by a digital control system suitable for and designed to control the movement of the TIG torch. The process according to the invention may be manual, automatic, or even robotic.

In the context of transfer via a liquid bridge 3, the process of the invention is preferably implemented with a TIG torch with filler wire 1 passing through the wall of the nozzle used to distribute the shielding gas mixture at an angle α of less than 50°, for example a torch similar or identical to that described in document EP-A-1459831.

In order to demonstrate the effectiveness of the process according to the invention for the cladding of metal parts, cladding trials were carried out on parts of a thickness of 60 mm formed from 304L stainless steel.

A first cladding trial was carried out on a part made of 304L stainless steel with a filler wire of 1.2 mm diameter. The cladding parameters were the following:
the shielding gas mixture contained 20% helium and 80% argon (% by volume), corresponding to the ARCAL32 mixture sold by AIR LIQUIDE;
the distance D separating the electrode from the end of the wire was 1 mm;
the angle α made between the axis of the non-consumable electrode and the filler wire was 20°;
the axis of the electrode was perpendicular to the surface of the part to be clad, i.e. made an angle of 0° to the vertical;
the apex angle of the TIG electrode was 40°;
the TIG torch was supplied with a smooth current of 400 A;
the arc voltage was about 16 V;
the speed of movement of the electrode and of the end of the consumable wire, i.e. the speed of movement of the torch, relative to the surface of the part was 1 m/min;
the distance between the end of the electrode 2c and the parts to be welded was 3 mm;
the feed speed of the consumable wire was 3.5 m/min; and
the deposition rate was 4.5 kg/h.

The metal deposit obtained in these trials had a regular appearance, good metallurgical properties, better wetting and a degree of dilution of about 10%. The coated part was exempt from deformations.

These results prove that the use of a shielding mixture comprising at least 20% helium allows the morphology of the deposits produced to be improved and the heat delivered by the arc to the molten puddle to be increased, thereby especially allowing the feed speed of the wire, the cladding speed and/or the deposition rate to be increased. In particular, the use of a shielding gas mixture comprising at least 20% helium significantly influences the wetting of the deposits, thereby allowing a surface geometry containing few or even no recesses or bumps to be obtained.

A second welding trial was carried out with a shielding gas mixture containing 70% helium and 30% argon (% by volume), corresponding to the ARCAL37 mixture sold by AIR LIQUIDE, all the other conditions otherwise being equal. A higher helium content yielded even better wetting and an even higher speed of advance.

Other trials were carried out with gas mixtures containing less than 20% helium or more than 70% helium. At less than 20% helium, the influence of the helium on the morphology of the deposits and the productivity of the cladding process was not detectable. At more than 70% helium, difficulties with striking and instabilities in the electrical arc appear.

The results of these trials confirm the advantageousness of the use of an He/Ar gas mixture to improve the performance of a cladding process in terms of productivity and the morphology of the deposits produced, provided the concentration of helium in the shielding mixture is comprised between 20 and 70%.

1-10. (canceled)

11: A process for cladding at least one portion of a metal part, said process comprising a non-consumable electrode, a consumable metal filler wire, and an electric arc drawn between the electrode and the part thereby producing a molten metal pool, the end of the metal filler wire being melted by the electric arc so as to achieve a transfer of molten metal from the filler wire to the molten metal pool and to coat at least one portion of the part with a metal deposit, wherein a shielding gas is used to shield the electrode, the filler wire and the pool, with a gas mixture consisting of 20 to 70% helium, and argon for the rest (% by volume).

12: The process of claim 11, wherein said gas mixture contains at most 50% helium (% by volume).

13: The process of claim 11, wherein said gas mixture contains at most 30% helium (% by volume).

14: The process as of claim 11, wherein the transfer of molten metal to the molten metal pool is achieved via a liquid bridge so as to have a permanent contact between said pool and the molten end of the filler wire.

15: The process of claim 11, wherein the end of the filler wire is guided to make an angle comprised between 5 and 50° to the axis of the electrode.

16: The process of claim 11, wherein the end of the filler wire is guided and permanently maintained at a distance (D) smaller than 2 mm from the end of the electrode.

17: The process of claim 11, wherein the end of the filler wire is guided so as to make an angle comprised between 10 and 25° to the axis of the electrode.

18: The process of claim 11, wherein the non-consumable electrode is made of tungsten.

19: The process of claim 11, wherein the part to be clad and/or the metal deposit deposited on said part is made of carbon steel, stainless steel, a nickel-based alloy or a cobalt-based alloy.

20: The process of claim 11, wherein the metal deposit has a thickness comprised between 1 and 20 mm.
